(19) United States
(12) Patent Application Publication
(10) Pub. No.: US 2012/0035018 A1
(43) Pub. Date: Feb. 9, 2012

(54) CLUTCH CONTROL METHOD

(75) Inventor: Sung Sik CHOI, Hwaseong-si (KR)

(73) Assignee: Hyundai Motor Company, Seoul (KR)

(21) Appl. No.: 12/951,854

(22) Filed: Nov. 22, 2010

(30) Foreign Application Priority Data
Aug. 9, 2010 (KR) 10-2010-0076472

(51) Int. Cl. B60W 10/02; B60W 10/10

(52) U.S. Cl. 477/79

(57) ABSTRACT

A clutch control may include a starting clutch that is disposed at a rear portion of an engine, an automatic transmission that is disposed at a rear portion of the starting clutch and uses a shifting element to vary a rotation ratio between an input shaft and an output shaft thereof, a driving wheel that receives a torque of the engine through the starting clutch and the automatic transmission to move a vehicle, and a control portion that combinatively slips the starting clutch and the shifting element. Accordingly, the starting clutch and the shifting element (clutch element or brake element) of the transmission are combinatively slip-controlled such that the friction energy is reduced, and the durability and the transmission efficiency are improved.

### CROSS-REFERENCE TO RELATED APPLICATION

This application claims priority to and the benefit of Korean Patent Application No. 10-2010-0076472 filed in the Korean Intellectual Property Office on Aug. 9, 2010, the entire contents of which application is incorporated herein for all purposes by this reference.

### BACKGROUND OF THE INVENTION

1. Field of the Invention

The present invention relates to a clutch control method. More particularly, the present invention relates to a clutch control method that uses a clutch disposed between an engine and a transmission to transfer torque of the engine to the transmission.

2. Description of the Related Art

A clutch is disposed between an engine and a transmission, and the clutch slips by a controller or a clutch pedal so as to smoothly and efficiently transfer torque of the engine to the transmission.

Generally, a starting clutch slips to smoothly transfer the torque of the engine, and the starting clutch absorbs friction energy caused by the slip.

Meanwhile, there is no large problem while instantaneous friction caused by a quick start is formed in the starting clutch.

However, in a case that the starting clutch slips for a long time in a long uphill slope, a friction member of the starting clutch is heated by friction energy to a high temperature such that the durability thereof is deteriorated.

Particularly, in a case that a battery is sufficiently charged in a hybrid vehicle, since the motor moves the vehicle there is no slip problem of the starting clutch, however, in a case that a battery is not sufficiently charged, since the starting clutch slips, there can be a problem in terms of slip control.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a clutch control method having advantages of improving durability in a case that a starting clutch is being operated for a long time.

A clutch control method according to an exemplary embodiment of the present invention may include a starting clutch that is disposed at a rear portion of an engine, an automatic transmission that is disposed at a rear portion of the starting clutch and uses a shifting element to vary a rotation ratio between an input shaft and an output shaft thereof, a driving wheel that receives a torque of the engine through the starting clutch and the automatic transmission to move a vehicle, and a control portion that combinatively slips the starting clutch and the shifting element.

The shifting element may include a clutch element or a brake element that selectively fixes or moves one side of a planetary gear.

The clutch element or the brake element may be used while a gear step of the automatic transmission is changed from N (neutral) to D (drive).

As stated above, in the engine system according to the present invention, the starting clutch and the shifting element (clutch element or brake element) of the transmission are combinatively slip-controlled such that the friction energy is reduced, and the durability and transmission efficiency are improved.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram of an exemplary engine system according to the present invention.

FIG. 2 is a schematic diagram related to combination control of an exemplary engine system according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

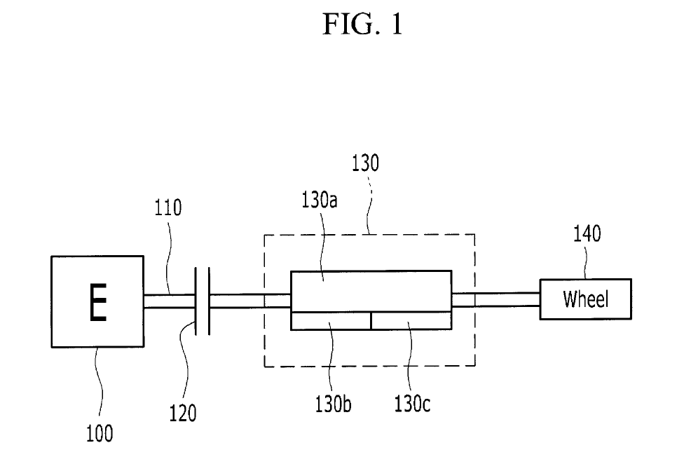

Referring to FIG. 1, an engine system includes an engine 100, a torque transmission shaft 110, a starting clutch 120, an automatic transmission 130, and a driving wheel 140, and the automatic transmission 130 includes a planetary gear 130a, and a clutch element 130b and a brake element 130c as shifting elements.

The starting clutch 120 supplies the automatic transmission 130 with torque of the engine 100.

The automatic transmission 130 selectively operates the clutch element 130b or the brake element 130c as a shifting element such that the planetary gear 130a can vary a rotation speed transferred from the starting clutch 120 and then transfer it to the driving wheel 140.

A control portion combinatively slips the starting clutch 120, the clutch element 130b, or the brake element 130c according to a driving condition of the engine 100 in various embodiments of the present invention so as to transfer the engine 100 torque to the driving wheel 140.

When only the starting clutch 120 slips, the temperature is raised due to excessive slip and the durability can be deteriorated. However, the starting clutch 120, the clutch element 130b, or the brake element 130c is combinatively slip-controlled in various embodiments of the present invention so as to prevent durability deterioration due to excessive slip.

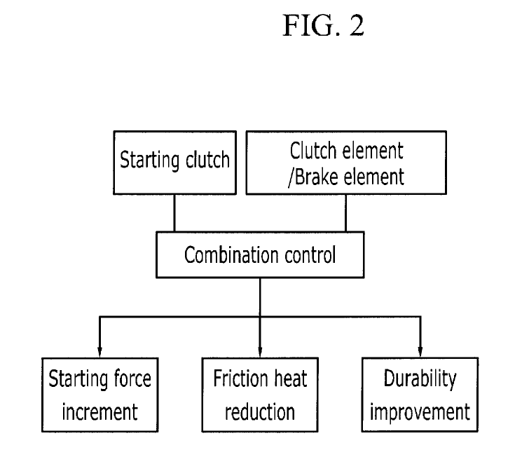

Referring to FIG. 2, the control portion combinatively stops the starting clutch 120 and the clutch element 130b or brake element 130c as a shifting element to increase a starting force, to reduce friction heat formed in the starting clutch 120 and the shifting element (clutch element or brake element), and to improve the durability thereof.

In conventional clutch control methods, the conventional clutch starting force equals starting clutch starting force (friction area*a number of friction surfaces*2*friction material area*piston pressure*valid radius), or:

C_{conv}=C_{sƒ}=(A_{ƒ}*N_{ƒs}*2*A_{ƒm}*Pₚ*Rᵥ) Eq. (a)

This invention starting force equals the conventional starting force in addition to the clutch element starting force (friction area*a number of friction surface*2*friction material area*piston pressure*valid radius), or:

Cᵢₙᵥ=C_{conv}+C_{sƒ}=C_{conv}+(A_{ƒ}*N_{ƒs}*2*A_{ƒm}*Pₚ*Rᵥ) Eq. (b)

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A clutch control method, comprising:
a starting clutch that is disposed at a rear portion of an engine;
an automatic transmission that is disposed at a rear portion of the starting clutch and uses a shifting element to vary a rotational ratio between an input shaft and an output shaft thereof;
a driving wheel that receives a torque of the engine through the starting clutch and the automatic transmission to move a vehicle; and
a control portion that cooperatively slip the starting clutch and the shifting element.

2. The clutch control method of claim 1, wherein the shifting element includes a clutch element or a brake element that selectively fixes or moves one side of a planetary gear.

3. The clutch control method of claim 2, wherein the clutch element or the brake element is used while a gear step of the automatic transmission is changed from N (neutral) to D (drive).

4. The clutch control method of claim 2, wherein a starting force=a conventional starting force +a clutch element starting force (friction area*a number of friction surface*2*friction material area*piston pressure*valid radius).
